(19) United States
(12) Patent Application Publication
(10) Pub. No.: US 2015/0022358 A1
(43) Pub. Date: Jan. 22, 2015

(54) ANTI-COUNTERFEIT AND ANTI-THEFT BUTTONS

(71) Applicants: Sheng-Chang Huang, Kaohsiung City (TW); SUPREME TECHNIC PACKAGE CO., LTD., Kaohsiung City (TW)

(72) Inventor: SHENG-CHANG HUANG, KAOHSIUNG CITY (TW)

(21) Appl. No.: 13/947,003

(22) Filed: Jul. 19, 2013

(51) Int. Cl. G06K 19/077

(52) U.S. Cl. CPC G06K 19/0775
USPC 340/572.7

(57) ABSTRACT

Anti-counterfeit and anti-theft buttons include at least a body embedded with a RFID system containing one or plural RFID chips. Each RFID chip may be of a single or double or multiple frequencies. If the single frequency is used, it may be a high frequency (HF) or an ultrahigh frequency (UHF). If the double frequencies are used, they may be any composition of HF and UHF. If the multiple frequencies are used, they may be a single HF and plural UHF, or plural HF and single UHF. The RFID chip is jointed with an antenna that may be of a single or multiple circuits and should have an extended antenna. All antennas can enhance effects of receiving signals. When two of these buttons fitted together are illegally separated, a system host may operate to give out warning signals or sound, achieving counterfeit and theft prevention.

### BACKGROUND OF THE INVENTION

1. Field of the Invention

This invention relates to anti-counterfeit and anti-theft buttons, particularly to ones having a body embedded with a RFID system containing one or plural RFID chips, with each RFID chip being of a single or double or multiple frequencies and jointed with an antenna that may be of a single or multiple circuits. Combined with an extended antenna, an auxiliary antenna that the button body has can enhance effects of receiving signals. If two of these buttons fitted together are illegally separated, a system host may operate to give out warning signals or sound, achieving counterfeit and theft prevention.

2. Description of the Prior Art

Commonly, commodities sold in open markets, department stores or supermarkets are engaged with conventional anti-theft buttons to prevent them from being stolen. As an article is sold out, the anti-theft button is to be detached from it by a particular tool at a checkout counter so that the article can be brought away through an anti-theft door without posing warning alarm. With each article engaged with an anti-theft button before selling out and separated from it after selling out, it takes a complicated process stepping up cost and making management uneasy to control.

Next, as disclosed in Taiwan Patent No. M370789, an “RFID anti-theft device” mainly includes a RFID tag and a displaying member. The RFID tag has a memory pertaining to information of a corresponding object, with one end formed as a binding portion and another end formed as an extending portion able to be curved in an annular figure to combine with the binding portion, shaped as a ring to hook around a necklace, a handlace, a footlace, a bracelet, a brooch or an earring. The displaying member is provided with a RFID reader, and an antenna installed around a supporting portion used to be laid with articles. The RFID reader can read an article information stored in the RFID tag through the antenna to identify whether the article is positioned on the displaying member or not, achieving an anti-theft purpose. However, as the RFID anti-theft device has to combine the annular RFID tag with the displaying member to achieve an anti-theft purpose, it also takes a complicated process with cost soared, only available for high-priced articles, not for tiny cheap articles or flexible articles, such as clothes.

### SUMMARY OF THE INVENTION

The object of this invention is to offer anti-counterfeit and anti-theft buttons that can be fastened on a wide variety of merchandises in open markets to prevent them from being illegally taken out of markets.

The anti-counterfeit and anti-theft buttons include a body embedded with a RFID system containing one or plural RFID chips. Each RFID chip may be of a single or double or multiple frequencies. If the single frequency is used, it may be a high frequency (HF) or an ultrahigh frequency (UHF). If the double frequencies are used, they may be any composition of HF and UHF. If the multiple frequencies are used, they may be a single HF and plural UHF, or plural HF and single UHF. The RFID chip is jointed with an antenna that may be of a single or multiple circuits, but whether it is single or multiple, it should have an extended antenna. Combined with the extended antenna, an auxiliary antenna that the button body has can enhance effects of receiving signals.

In this invention, it is mainly using two corresponding buttons to lock with each other to make their antennas contacting with each other, forming a short or a closed circuit. When two of these buttons fitted together are illegally separated, a system host may operate to give out warning signals or sound, achieving counterfeit and theft prevention.

### BRIEF DESCRIPTION OF DRAWINGS

This invention is better understood by referring to the accompanying drawings, wherein:

FIG. 1 is a perspective view of a first preferred embodiment of anti-counterfeit and anti-theft buttons in the present invention;

FIG. 2 is a cross-sectional view of the first preferred embodiment of anti-counterfeit and anti-theft buttons in the present invention;

FIG. 3A is a top view of a first embodiment of a RFID chip and its antenna with a single circuit in the present invention;

FIG. 3B is a top view of a second embodiment of a RFID chip and its antenna with double circuits in the present invention;

FIG. 3C is a top view of a third embodiment of a RFID chip and its antenna with triple circuits in the present invention;

FIG. 3D is a top view of a fourth embodiment of two RFID chips and their antennas respectively with a single circuit in the present invention;

FIG. 3E is a top view of a fifth embodiment of two RFID chips and their antennas respectively with double circuits in the present invention;

FIG. 4 is an exploded perspective view of a first embodiment of a RFID system, showing the second embodiment of the RFID chip and its antenna to be combined under a substrate in the present invention;

FIG. 5 is an exploded perspective view of a RFID system and an auxiliary antenna before combined together in the present invention;

FIG. 6 is a perspective view of the RFID system and the auxiliary antenna after combined together;

FIG. 7 is an exploded perspective view of the first embodiment of the buttons and an engaging element before engaged with each other in the present invention;

FIG. 8 is a cross-sectional view of the first embodiment of the buttons and a first embodiment of the engaging element after engaged with each other in the present invention;

FIG. 9 is a cross-sectional view of the first embodiment of the buttons and a second embodiment of the engaging element after engaged with each other in the present invention;

FIG. 10A is a cross-sectional view of two buttons of the first embodiment locked with each other in the present invention;

FIG. 10B is a perspective view of FIG. 10A;

FIG. 11 is a cross-sectional view of a second preferred embodiment of anti-counterfeit and anti-theft buttons in the present invention;

FIG. 12 is an exploded perspective view of a second embodiment of a RFID system, showing the second embodiment of the RFID chip and its antenna to be combined on a substrate in the present invention;

FIG. 13 is a cross-sectional view of the second embodiment of the RFID system in the present invention;

FIG. 14 is a cross-sectional view of the second embodiment of the buttons combined with the engaging element in the present invention; and

FIGS. 15A˜15C are illustrations showing the buttons of the invention practically fastened on clothes, shoes and bags.

### DETAILED DESCRIPTION OF THE PREFERRED EMBODIMENT

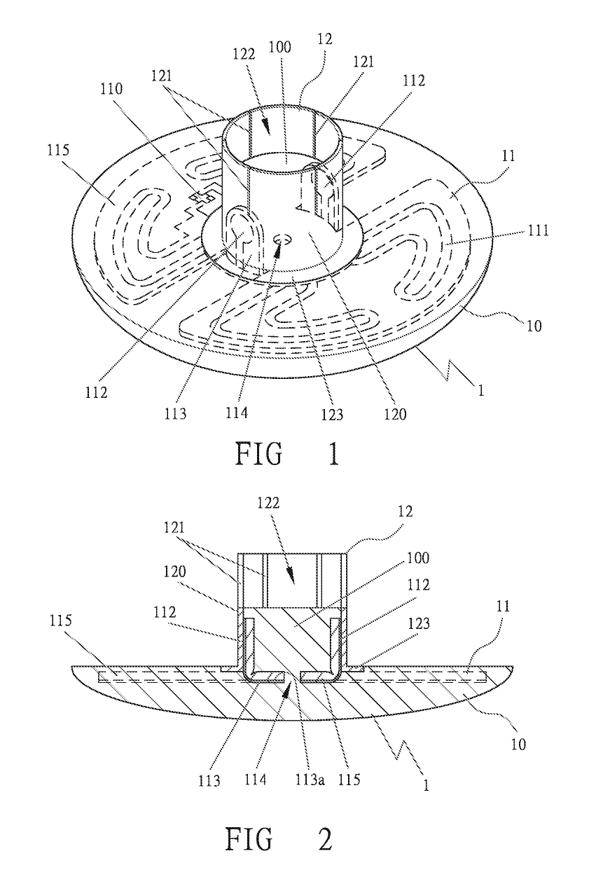

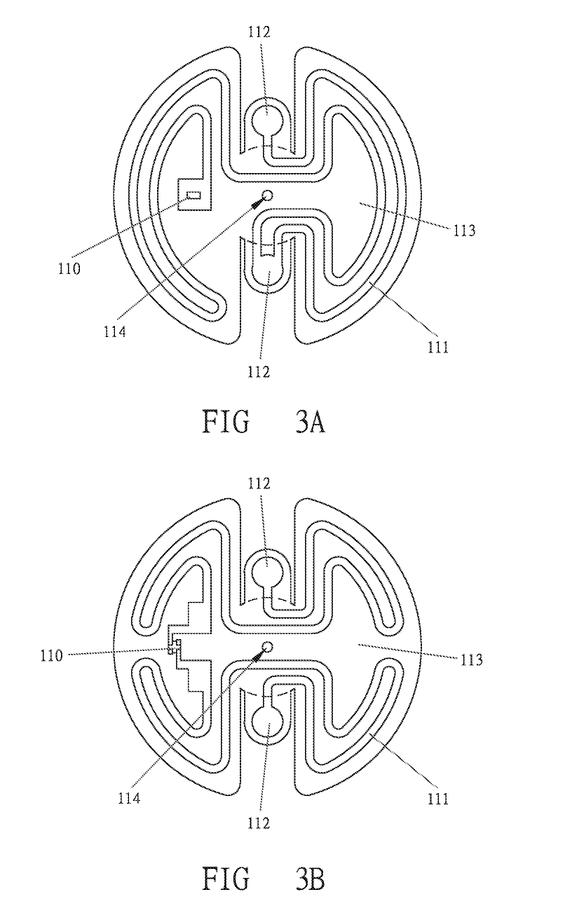

As shown in FIGS. 1 and 2, a first preferred embodiment of an anti-counterfeit and anti-theft button 1 in the present invention includes a body 10 embedded with a RFID (radio frequency identification) system 11 composed of at least a RFID chip 110, an antenna 111 and a substrate 115. If a single RFID chip 110 is applied in the RFID system 11, it may be one with a HF (high frequency) or an UHF (ultra high frequency). If two or more RFID chips 110 are provided in the RFID system 11, they may be ones with the same single frequency of HF or UHF, or one with a HF and another with an UHF, so as to gain a double-frequency or multi-frequency RFID chip set. If only a single RFID chip 110 is used in the RFID system 11, its antenna 111 may be of a single circuit or multiple circuits. If two or more RFID chips 110 are used in the RFID system 11, their antennas 111 respectively may as well be of a single circuit or multiple circuits. Whether the antenna 111 is of a single or multiple circuits, it should have an extended antenna 112 and be connected with an auxiliary antenna 12 of the body 10. The number of extended antenna 112 may be one or two or more than two.

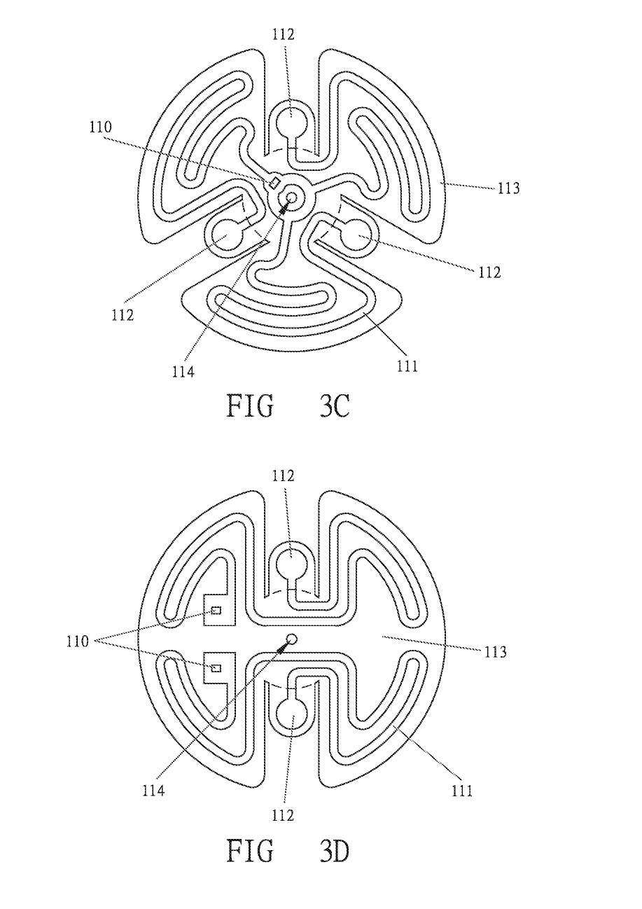

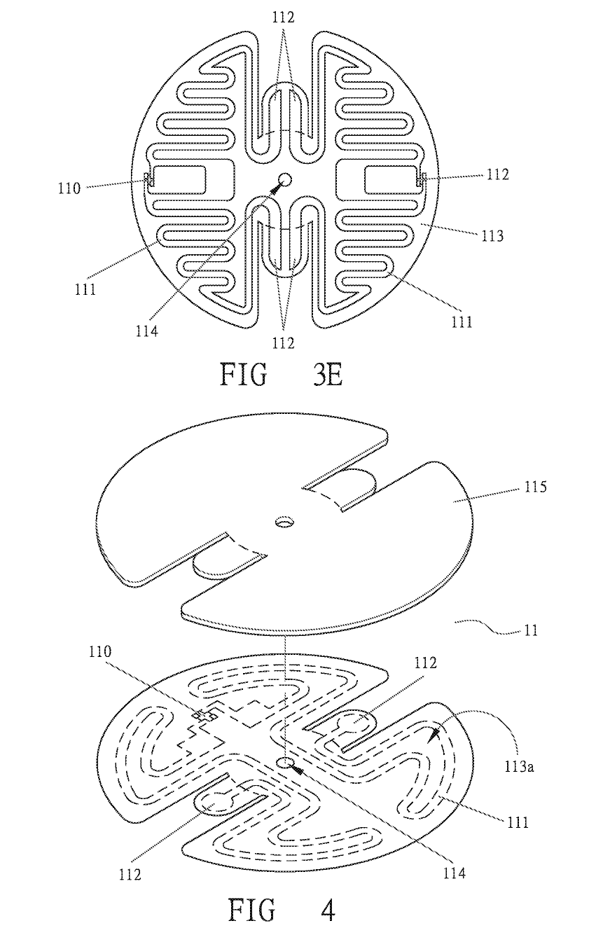

FIG. 3A shows a first embodiment of installing the RFID chip 110 and the antenna 111 of the RFID system 11 in a circuit board 113. In this embodiment, the RFID system 11 contains a single RFID chip 110 that is of HF or UHF, and the antenna 111 is of a single circuit. Two extended antennas 112 are located at proper positions of the antenna 111, partly separated from the circuit board 113 for being appropriately curved toward one side. The circuit board 113 is properly bored with a hole 114 provided as a flowing hole to cast raw plastics.

FIG. 3B shows a second embodiment of installing the RFID chip 110 and the antenna 111 of the RFID system 11 in a circuit board 113. In this embodiment, the RFID system 11 contains a single RFID chip 110 that is of HF or UHF, and the antenna 111 is of double circuits. Two extended antennas 112 are located at proper positions of the antenna 111, partly separated from the circuit board 113 for being appropriately curved toward one side. The circuit board 113 is properly bored with a hole 114 provided as a flowing hole to cast raw plastics.

FIG. 3C shows a third embodiment of installing the RFID chip 110 and the antenna 111 of the RFID system 11 in a circuit board 113. In this embodiment, the RFID system 11 contains a single RFID chip 110 that is of HF or UHF, and the antenna 111 is of triple circuits or more. Three extended antennas 112 are located at proper positions of the antenna 111, partly separated from the circuit board 113 for being appropriately curved toward one side. The circuit board 113 is properly bored with a hole 114 provided as a flowing hole for casting raw plastics.

FIG. 3D shows a fourth embodiment of installing the RFID chip 110 and the antenna 111 of the RFID system 11 in a circuit board 113. In this embodiment, the RFID system 11 contains two RFID chips 110 that are of the same HF or

UHF or of HF and UHF, and the antenna 111 is of double circuits. Each of the RFID chips 110 is connected with an antenna 111 that is installed with an extended antenna 112 at a proper position, with the extended antenna 112 partly separated from the circuit board 113 for being appropriately curved toward one side. The circuit board 113 is properly bored with a hole 114 provided as a flowing hole for casting raw plastics.

FIG. 3E shows a fifth embodiment of installing the RFID chip 110 and the antenna 111 of the RFID system 11 in a circuit board 113. In this embodiment, the RFID system 11 contains two RFID chips 110 that are of the same HF or UHF or of HF and UHF, and the antenna 111 is of double circuits. Each of the RFID chips 110 is connected with an antenna 111 that is installed with two extended antennas 112 at proper positions, with the extended antennas 112 partly separated from the circuit board 113 for being appropriately curved toward one side. The circuit board 113 is properly bored with a hole 114 provided as a flowing hole for casting raw plastics.

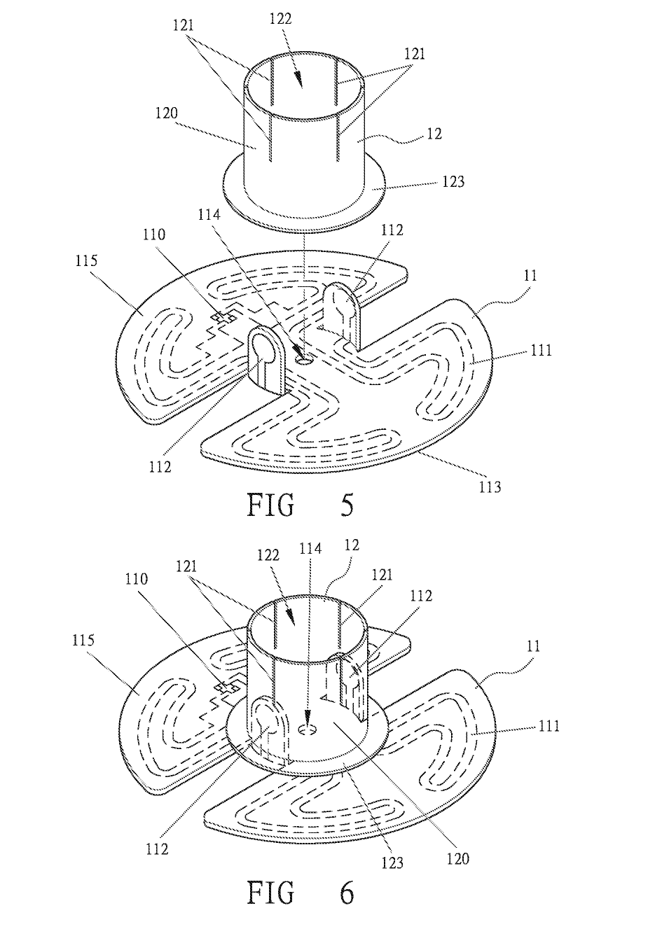

A first embodiment of the RFID system 11 may be a combination of one of the embodiments shown in FIGS. 3A˜3E and the substrate 115. As shown in FIG. 4, the first embodiment of the RFID system 11 is illustrated by combining the second embodiment of the RFID chip 110 and the antenna 111, shown in FIG. 3B, with the substrate 115. With a blank rear side 113a of the circuit board 113 adhesively attached with one side of the substrate 115, the RFID system 11 is finished.

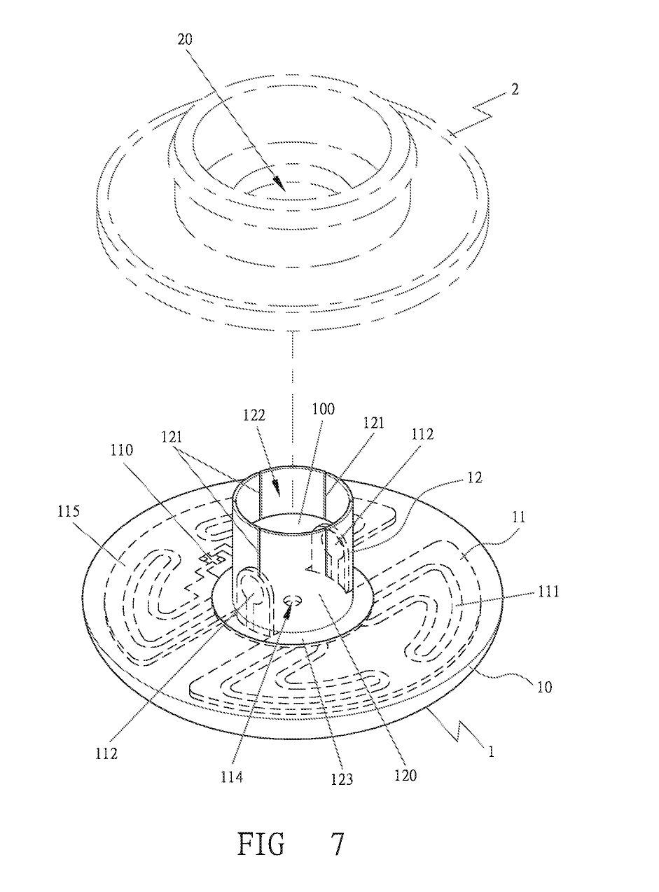

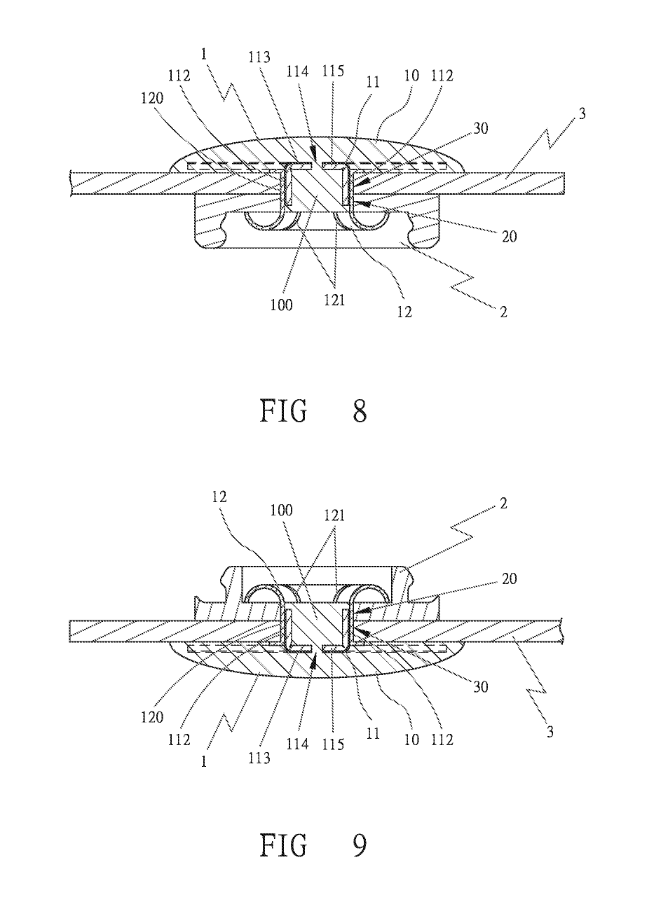

As shown in FIGS. 5 and 6, the extended antennas 112 of the RFID system 11 have to be curved toward one side when the RFID system 11 is to be combined with the body 10 of the button 1. As mentioned previously, with the antenna 111 installed in the circuit board 113 and the substrate 115 attached with the rear side 113a of the circuit board 113, part of the circuit board 113 and part of the substrate 115 are simultaneously bent as the antenna 112 is curved up. By means of proper rigidity of the substrate 115, the antenna 112 can be steadily shaped as expected after curved up. Next, with the support of the circuit board 113 and the substrate 115 to keep the extended antenna 112 steadily curved, the auxiliary antenna 12 made of metal (copper preferred) is worn on the outside of the extended antenna 112 to contact with it.

Further, as shown in FIGS. 5 and 6, the auxiliary antenna 12 is provided with a sleeve 120 that is or is not provided with plural slots 121 cut from the top circumference with a proper length, a space 122 formed inside, and a joint circumference 123 surrounding the bottom. The space 122 is used to accommodate the curved extended antenna 112 to enable it to attach with the auxiliary antenna 12, with the joint circumference 123 closely contacting with the substrate 115.

As shown in FIGS. 1 and 2, the RFID system 11 and the auxiliary antenna 12 must be previously laid in a mold of the button 1 before injecting or extruding plastic material, so that the RFID system 11 can be embedded in the body 10 of the button 1 after injecting or extruding plastic material, with part of an extending portion 100 of the body 10 combined with the substrate 115 to accommodate the extended antenna 112. The extending portion 100 is employed to engage with the sleeve 120 of the auxiliary antenna 12, with the sleeve 120 positioned higher than the extending portion 100. Next, by combining the joint circumference 123 of the auxiliary antenna 12 with the body 10, the first embodiment of the button 1 is finished.

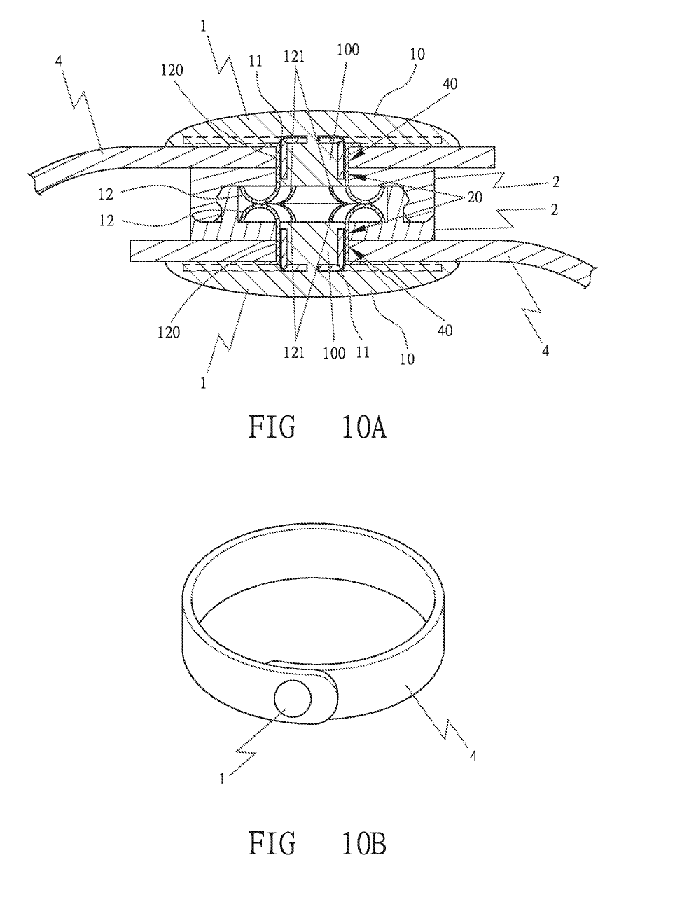

As a second embodiment of the button 1, it has to collaborate with an engaging element 2 to joint an article 3 (as shown in FIGS. 15A - 15C) expected to be protected from being stolen or replaced with a counterfeit. FIGS. 8 and 9 respectively show a first embodiment and a second embodiment of the engaging element 2. The article 3 has to be bored with a through hole 30 and the engaging element 2 is bored with a center hole 20. The extending portion 100 of the body 10 and the auxiliary antenna 12 are inserted through the through hole 30 and the center hole 20 consecutively, with the portion of the sleeve 120 of the auxiliary antenna 12 extended out of the extending portion 100 of the body 10 bent properly by a tool to press on another side of the engaging element 2 owing to the slots 121 cut in the sleeve 120, thus enabling the article 3 fixedly sandwiched between the button 1 and the engaging element 2. Therefore, if the button 1 is illegally broken, the antenna is to have a short circuit or a broken circuit able to be detected by a system host to start a warning signal or sound; if a signal sent out by a legal tool is received, the button 1 can be legally separated to carry out commodity transaction.

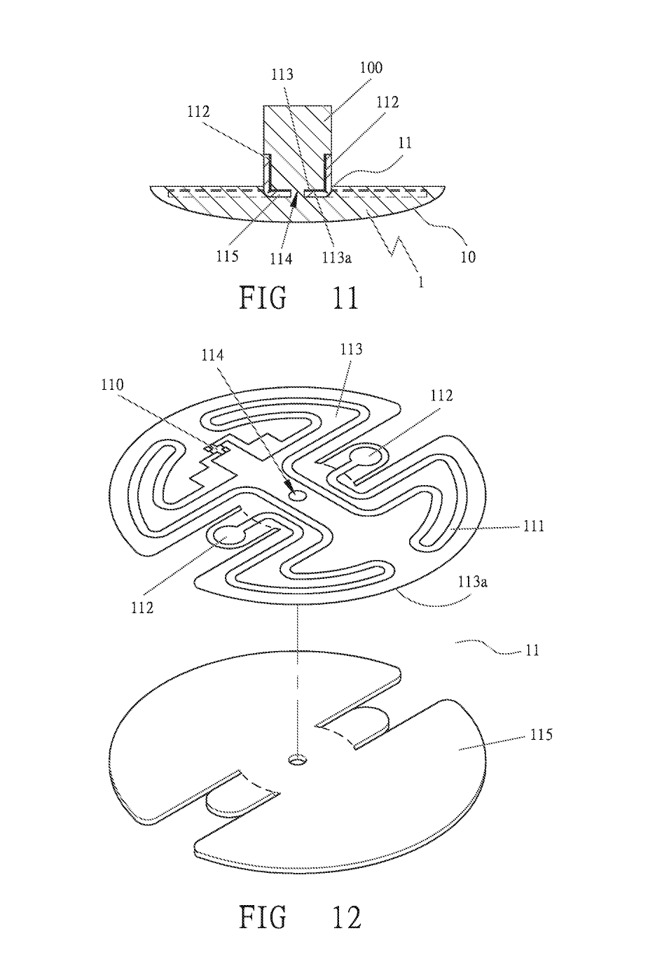

FIGS. 10A and 10B show the first embodiment of the button 1 combined with a belt 4 to fasten an article A. Two ends of the belt 4 are respectively bored with a through hole 40 for the button 1 to fix with. The extending portion 100 of the body 10 and the auxiliary antenna 12 are inserted through the through hole 40 and the center hole 20 of the engaging element 2 consecutively, with the portion of the sleeve 120 of the auxiliary antenna 12 extended out of the extending portion 100 of the body 10 bent properly by a tool to press on another side of the engaging element 2 owing to the slots 121 cut in the sleeve 120, thus enabling the belt 4 fixedly sandwiched between the button 1 and the engaging element 2. To protect the article A from being counterfeited or stolen, the belt 4 can be fastened on the article A at a proper position, as shown in FIGS. 15A and 15B, with two buttons 1 at two ends of the belt 4 locked with each other to make each other's auxiliary antennas 12 contacted, making a short circuit or broken circuit for signals of the RFID chips. Therefore, if the buttons 1 are illegally separated from each other, the system host is able to detect abnormal signals to start a warning signal or sound; if a signal sent out by a legal tool is received, the buttons 1 can be legally separated from each other to carry out commodity transaction.

As shown in FIG. 11, a second preferred embodiment of an anti-counterfeit and anti-theft button 1, derived from the first one, in the present invention includes a body 10 embedded with a RFID (radio frequency identification) system 11 (referred to FIGS. 3A˜3E) composed of at least a RFID chip 110 and an antenna 111. If a single RFID chip 110 is applied in the RFID system 11, it may be one with a HF (high frequency) or an UHF (ultra high frequency). If two or more RFID chips 110 are provided in the RFID system 11, they may be ones with the same single frequency of HF or UHF, or one with a HF and another with an UHF, so as to gain a double-frequency or multi-frequency RFID chip set. If only a single RFID chip 110 is used in the RFID system 11, its antenna 111 may be of a single circuit or multiple circuits. If two or more RFID chips 110 are used in the RFID system 11, their antennas 111 respectively may as well be of a single circuit or multiple circuits. Whether the antenna 111 is of a single or multiple circuits, it should at least have an extended antenna.

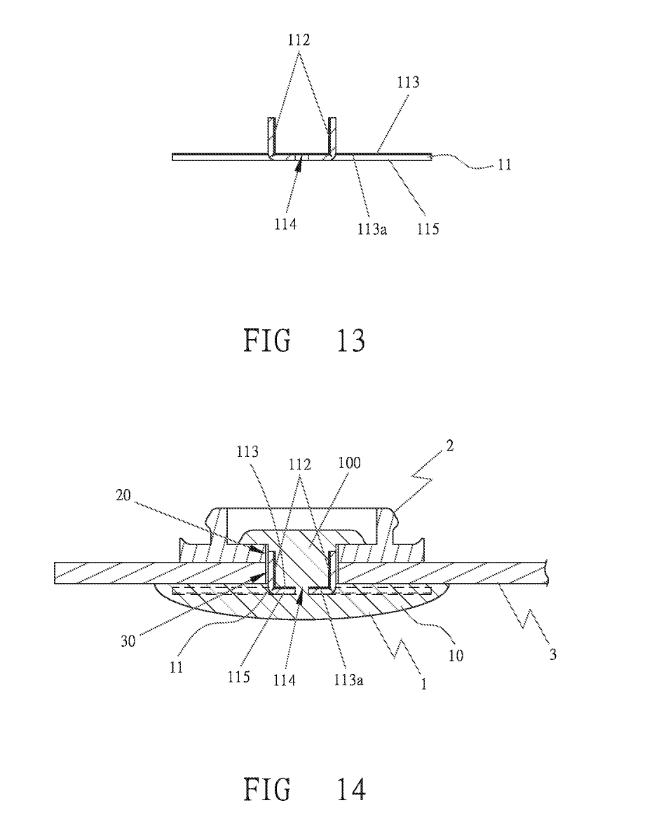

A second embodiment of the RFID system 11 may be a combination of one of the embodiments shown in FIGS. 3A˜3E and a substrate 115. As shown in FIG. 12, the second embodiment of the RFID system 11 is illustrated by combining the second embodiment of the RFID chip 110 and the antenna 111, shown in FIG. 3B, with the substrate 115. With the blank rear side 113a of the circuit board 113 adhesively attached with another side of the substrate 115, the RFID chip 110 and the antenna 111 are positioned in an upper surface of the RFID system 11, different from those positioned in a bottom surface of the first embodiment of the RFID system 11 shown in FIG. 4.

As shown in FIG. 13, the extended antennas 112 of the RFID system 11 have to be curved toward one side when the RFID system 11 is to be combined with the body 10 of the button 1. As mentioned previously, with the antenna 111 installed in the circuit board 113 and the substrate 115 attached with the rear side 113a of the circuit board 113, part of the circuit board 113 and part of the substrate 115 are simultaneously bent as the antenna 112 is curved up.

As shown in FIG. 11, the RFID system 11 must be previously laid in a mold of the button 1 before injecting or extruding plastic material, so that the RFID system 11 can be embedded in the body 10 of the button 1 after injecting or extruding plastic material, with part of an extending portion 100 of the body 10 combined with the substrate 115 to accommodate the extended antenna 112 to enable the RFID system 11 to receive signals from a system host with enhancement, to timely send out warning signals or sound for an anti-counterfeit and an anti-theft purpose.

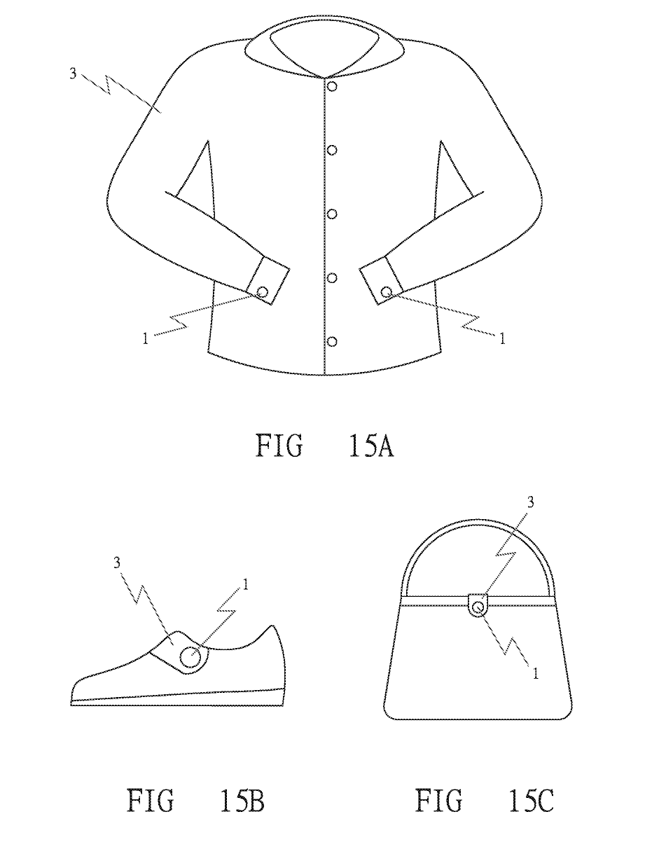

In using, as shown in FIG. 14, the button 1 of the second embodiment has to collaborate with an engaging element 2 to joint an article 3 (as shown in FIGS. 15A˜15C) for counterfeit and theft prevention. The article 3 has to be bored with a through hole 30 and the engaging element 2 is bored with a center hole 20. The extending portion 100 of the body 10 is inserted through the through hole 30 and the center hole 20 consecutively, with the extending portion 100 of the body 10 softened properly by a high frequency machine or other thermo methods to press on another side of the engaging element 2 around the center hole 20, thus enabling the article 3 fixedly sandwiched between the button 1 and the engaging element 2. Therefore, if the button 1 is illegally broken, the antenna is to have a short circuit or a broken circuit able to be detected by a system host to start a warning signal or sound; if a signal sent out by a legal tool is received, the button 1 can be legally separated to carry out commodity transaction.

With the RFID system provided with a RFID chip, an antenna and its extended antenna, the buttons of the invention can receive signals with enhancement, able to protect open commodities from being stolen or even illegally replaced with counterfeit ones, thus advancing practical commodity management.

While the preferred embodiment of the invention has been described above, it will be recognized and understood that various modifications may be made therein and the appended claims are intended to cover all such modifications that may fall within the spirit and scope of the invention.

What is claimed is:

1. Anti-counterfeit and anti-theft buttons comprising:
a body embedded with a RFID (radio frequency identification) system provided with at least a RFID chip and an antenna installed in a circuit board and a substrate, said antenna provided with one or two or more than two extended antennas that are attached with an auxiliary antenna to enable said antenna to receive signals with enhancement so as to achieve anti-counterfeit and anti-theft purposes.

2. The anti-counterfeit and anti-theft buttons as claimed in claim 1, wherein said RFID system is provided with one or two or more than two RFID chips.

3. The anti-counterfeit and anti-theft buttons as claimed in claim 2, wherein said single RFID chip is of a HF (high frequency) or a UHF (ultrahigh frequency).

4. The anti-counterfeit and anti-theft buttons as claimed in claim 2, wherein two or more than two said RFID chips provided in said RFID system may be ones with the same single frequency of HF or UHF, or one with a HF and another with an UHF, so as to gain a double-frequency or multi-frequency RFID chip set.

5. The anti-counterfeit and anti-theft buttons as claimed in claim 1, wherein said antenna is of a single circuit or multiple circuits for the RFID system containing only a single RFID chip.

6. The anti-counterfeit and anti-theft buttons as claimed in claim 1, wherein if two or more than two RFID chips are used in the RFID system, each of their antennas is of a single circuit or multiple circuits.

7. The anti-counterfeit and anti-theft buttons as claimed in claim 1, wherein said circuit board is installed with said RFID chip and said antenna, with a portion of said circuit board installed with said extended antenna partly separated from a portion of said circuit board installed with said antenna so that said extended antenna can be properly curved toward one side.

8. The anti-counterfeit and anti-theft buttons as claimed in claim 7, wherein said circuit board of said RFID system is bored with a hole provided as a flowing hole for casting raw plastics

9. The anti-counterfeit and anti-theft buttons as claimed in claim 1, wherein said circuit board of said RFID system has a rear side combined with said substrate.

10. The anti-counterfeit and anti-theft buttons as claimed in claim 1, wherein said auxiliary antenna is further provided with a sleeve that is or is not provided with plural slots, a space formed inside said sleeve, a joint circumference formed at a bottom of said sleeve, said space used to accommodate said curved extended antenna to enable it to attach with said auxiliary antenna, said joint circumference closely contacting with said substrate.

11. A method of manufacturing anti-counterfeit and anti-theft buttons, said method comprising:
laying a RFID system and an auxiliary antenna in a mold of said buttons in advance before injecting or extruding plastic material in said mold so that said RFID system can be embedded in a body of said button, part of an extending portion of said body combined with a substrate to accommodate an extended antenna, said extending portion of said body inserted in a space of said sleeve of said auxiliary antenna with said sleeve positioned higher than said extending portion, said auxiliary antenna provided with a joint circumference combined with said body, said body and said RFID system and said auxiliary antenna thus combined together to form as said button.

12. Anti-counterfeit and anti-theft buttons comprising:
a body embedded with a RFID (radio frequency identification) system provided with at least a RFID chip and an antenna installed in a circuit board and a substrate, said antenna provided with one or two or more than two extended antennas that are attached with an auxiliary antenna, said button having to collaborate with an engaging element, an article to be protected having to be bored with a through hole, said extending portion of said body and said auxiliary antenna inserted through said through hole of said article and a center hole of said engaging element consecutively with a portion of said sleeve of said auxiliary antenna extended out of said extending portion of said body bent properly by a tool owing to slots cut in said sleeve to press on another side of said engaging element so as to enable said article fixedly sandwiched between said button and said engaging element.

13. The anti-counterfeit and anti-theft buttons as claimed in claim 12, wherein said button is fixed at two ends of a belt, each end of said belt bored with a through hole, said extending portion of said body and said auxiliary antenna inserted through said through hole of said belt and said center hole of said engaging element consecutively with a portion of said sleeve of said auxiliary antenna extended out of said extending portion of said body bent properly by a tool owing to slots cut in said sleeve to press on another side of said engaging element so as to enable said belt fixedly sandwiched between said button and said engaging element.

14. Anti-counterfeit and anti-theft buttons comprising:
a body embedded with a RFID (radio frequency identification) system provided with at least a RFID chip and an antenna installed in a circuit board and a substrate, said antenna provided with one or two or more than two extended antennas that are installed on an extending portion of said body to enable said antenna to receive signals with enhancement so as to achieve anti-counterfeit and anti-theft purposes.

15. The anti-counterfeit and anti-theft buttons as claimed in claim 14, wherein said RFID system is provided with one or two or more than two RFID chips.

16. The anti-counterfeit and anti-theft buttons as claimed in claim 15, wherein said antenna is of a single circuit or multiple circuits for the RFID system containing only a single RFID chip.

17. The anti-counterfeit and anti-theft buttons as claimed in claim 15, wherein two or more than two said RFID chips may be ones with the same single frequency of HF or UHF, or one with a HF and another with an UHF, so as to gain a double-frequency or multi-frequency RFID chip set.

18. The anti-counterfeit and anti-theft buttons as claimed in claim 14, wherein said antenna is of a single circuit or multiple circuits for the RFID system containing only a single RFID chip.

19. The anti-counterfeit and anti-theft buttons as claimed in claim 14, wherein if two or more than two RFID chips are used in the RFID system, each of their antennas is of a single circuit or multiple circuits.

20. The anti-counterfeit and anti-theft buttons as claimed in claim 14, wherein said circuit board is installed with said RFID chip and said antenna, with a portion of said circuit board installed with said extended antenna partly separated from a portion of said circuit board installed with said antenna so that said extended antenna can be properly curved toward one side.

21. Anti-counterfeit and anti-theft buttons comprising:
a body embedded with a RFID (radio frequency identification) system provided with at least a RFID chip and an antenna installed in a circuit board and a substrate, said antenna provided with one or two or more than two extended antennas that are installed in an extending portion of said body, said button having to collaborate with an engaging element, an article to be protected having to be bored with a through hole, said extending portion of said body inserted through said through hole of said article and a center hole of said engaging element consecutively, said extending portion of said body then softened properly by a high frequency machine or other thermo methods to press on another side of said engaging element around said center hole to enable said article fixedly sandwiched between said button and said engaging element.
